(19) United States
(12) Patent Application Publication
(10) Pub. No.: US 2020/0263772 A1
(43) Pub. Date: Aug. 20, 2020

(54) TORQUE CONVERTER INCLUDING THRUST WASHER OF DIFFERENT AXIAL THICKNESS BETWEEN STATOR AND IMPELLER

(71) Applicants: Schaeffler Technologies AG & Co. KG, Herzogenaurach (DE); Schaeffler Group USA Inc., Fort Mill, SC (US)

(72) Inventors: Long He, North Canton, OH (US); Pankaj Madhukar Patil, Wooster, OH (US)

(21) Appl. No.: 16/067,947

(22) PCT Filed: Jan. 15, 2016
(86) PCT No.: PCT/US2016/013726

§ 371 Date: Jul. 3, 2018

(51) Int. Cl. F16H 41/24

(52) U.S. Cl. CPC F16H 41/24

(57) ABSTRACT

An axial thrust washer for a torque converter is provided. The axial thrust washer includes an inner circumferential surface; an outer circumferential surface; a first axial surface extending from the inner circumferential surface to the outer circumferential surface; and a second axial surface opposite the first axial surface. The second axial surface includes a plurality of radially inner pads and a plurality of radially outer pads. The radially inner pads extend axially further from the first axial surface than the radially outer pads. A torque converter and a method of forming a torque converter are also provided.

The present disclosure relates generally to torque converters and more specifically to thrust washers for torque converters.

### BACKGROUND

U.S. Publication No. 2015/0184701 A1 and CA 745520A disclose torque converter thrust washers.

### SUMMARY OF THE INVENTION

An axial thrust washer for a torque converter is provided. The axial thrust washer includes an inner circumferential surface; an outer circumferential surface; a first axial surface extending from the inner circumferential surface to the outer circumferential surface; and a second axial surface opposite the first axial surface. The second axial surface includes a plurality of radially inner pads and a plurality of radially outer pads. The radially inner pads extend axially further from the first axial surface than the radially outer pads.

A torque converter is also provided. The torque converter includes a stator; an impeller; and the axial thrust washer axially between the stator and the impeller.

A method of forming a torque converter is also provided. The method includes forming an axial thrust washer including an inner circumferential surface, an outer circumferential surface, a first axial surface extending from the inner circumferential surface to the outer circumferential surface and a second axial surface opposite the first axial surface. The second axial surface includes a plurality of radially inner pads and a plurality of radially outer pads. The radially inner pads extend axially further from the first axial surface than the radially outer pads. The method also includes aligning the radially inner pads with a radially inner section of a radially extending section of the impeller.

### BRIEF DESCRIPTION OF THE DRAWINGS

The present invention is described below by reference to the following drawings, in which:

FIG. 1 schematically shows a cross-sectional side view of a torque converter in accordance with an embodiment of the present invention;

FIG. 2 shows a perspective view of a section of an axial thrust washer of the torque converter shown in FIG. 1; and

FIG. 3 shows a plan view of the axial thrust washer shown in FIG. 2.

### DETAILED DESCRIPTION

The disclosure provides a hydrodynamic thrust washer including pads designed to reduce wear and drag between an axial surface of an impeller inner surface of a torque converter and the hydrodynamic thrust washer. Dual pads are introduced including pad geometries at higher heights nearer to the inner diameter of the hydrodynamic thrust bearing and pad geometries at lower heights nearer to the outer diameter, with tangential grooves separating the two pad regions. The pads are integral to the thrust washer, which in one preferred embodiment is formed of Torlon.

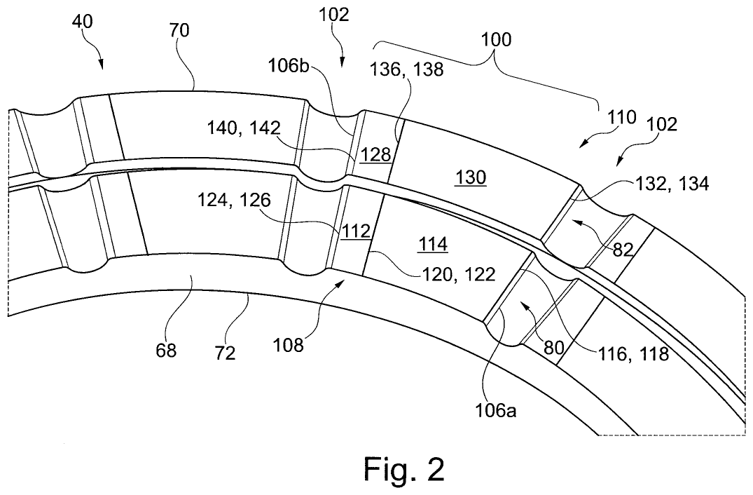

FIG. 2 shows a section of a torque converter 10 in accordance with an embodiment of the present invention. Torque converter 10 includes a turbine 12, an impeller 14 and a stator 16 axially between turbine 12 and impeller 14. Impeller 14 includes a hub section 18 extending axially and parallel to a center axis 20 of rotation of torque converter 10. As used herein, the terms axially, radially and circumferentially refer to a relationship to center axis 20. At a stator-side axial end of hub section 18, impeller 14 includes a radially extending section 22 extending radially outward from hub section 18 to a rounded blade supporting section 24 of impeller 14, which supports a plurality of impeller blades 26 on a stator-side axial surface thereof.

Stator 16 includes a casting 28, a one-way clutch 30 supporting casting 28 and a centering plate 32 holding one-way clutch 30 in place within an annular recess 34 formed in stator casting 28. One-way clutch 30 includes an inner race 36, an outer race 38 and rollers 39 radially between inner race 36 and outer race 38. Stator casting 28 is rotationally fixed to outer race 38, and depending on the operating conditions of torque converter 10, inner race 36 and outer race 38 are rotationally fixed to each other or rotatable relative to each other. An axial thrust washer 40 according to an embodiment of the present invention, which is described in further detail below, is provided between stator 16 and impeller 14.

Stator 16 includes a plurality of blades 42 for redirecting the torque converter fluid flowing from turbine 12 to impeller 14. Inner radial ends of blades 42 are supported on an outer circumferential surface 44 of a body 46 of stator casting 28. Stator body 46 includes annular recess 34 formed in an impeller-side axial surface 50 thereof receiving one-way clutch 30. Radially outside of annular recess 34, stator body 46 is provided with an annular recess 58 for receiving centering plate 32, and notches 60 extending radially outward from annular recess 58 for receiving snap-on connectors 62 of thrust washer 40.

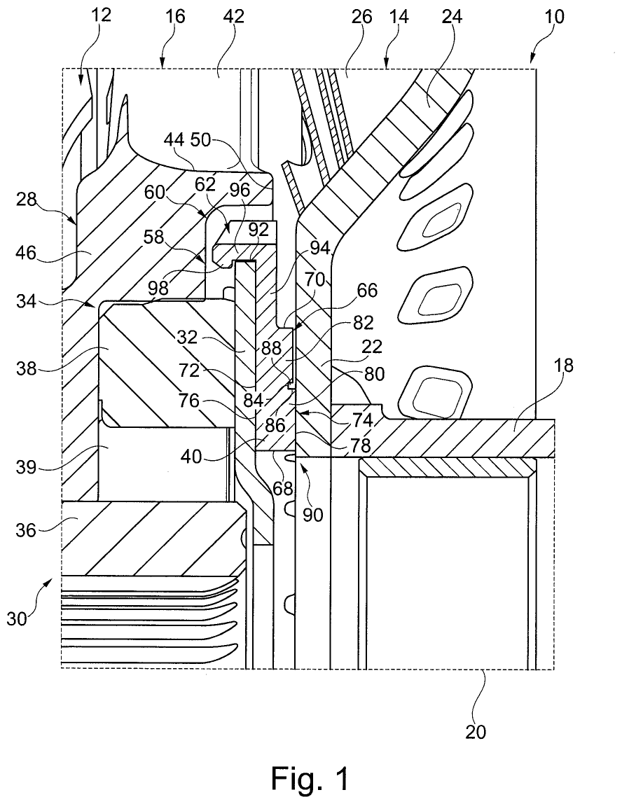

Thrust washer 40 includes an annular base 66 including an inner circumferential surface 68, an outer circumferential surface 70 and two axial surfaces 72, 74 extending radially from inner circumferential surface 68 to outer circumferential surface 70. Stator-side axial surface 72 sits flush against an impeller-side axial surface 76 of centering plate 32 and impeller-side axial surface 74 faces a stator-side axial surface 78 of radially extending section 22 of impeller 14. At impeller-side axial surface 74, thrust washer 40 is provided with a plurality of sets of pads, each set including a radially inner pad 80 and a radially outer pad 82. In this embodiments, pads 80, 82 are separated by a circumferentially extending groove 84 positioned between radially outer circumferentially extending surfaces 86 of radially inner pads 80 and radially inner circumferentially extending surfaces 88 of radially outer pads 82. As shown in FIG. 1, radially inner pads 80 extend further axially away from stator-side axial surface 74 than radially outer pads 82 and are positioned axially closer to radially extending section 22 of impeller 14 than radially outer pads 82. Accordingly, at radially inner pads 80, thrust washer 40 is thicker than at radially outer pads 82.

During operation of torque converter 10, ballooning may cause a radially inner section 90 of radially extending section 22 of impeller 14 to be forced axially away from stator 16 such that radially extending section 22 tapers axially away from stator 16 as radially extending section 22 extends radially inward towards center axis 20. Providing thrust washer 40 with axially offset pads 80, 82, in particular having radially inner pads 80 aligned with radially inner section 90, prevents the tapering of radially extending section 22 from having large differences in film thicknesses on axial surface 72, helping to minimize wear on axial surface 72.

Thrust washer 40 includes a plurality of circumferentially spaced connectors 62 for connecting thrust washer 40 to stator 16. More specifically, in this embodiment, connectors 62 are formed at a radially outer end of thrust washer 40 and snap onto an outer circumferential surface 92 of centering plate 32. Connectors 62 each include a radially extending section 94 extending radially outward from outer circumferential surface 70 of annular base 66, an axially extending section 96 extending axially toward stator 16 from the radially outer end of section 94 and a clip 98 extending radially inward from section 96.

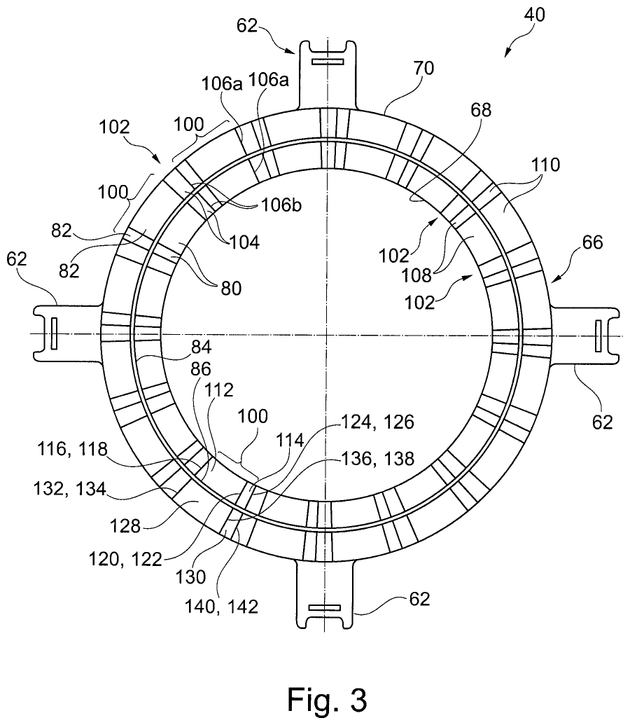

FIG. 2 shows a perspective view of a section of thrust washer 40 and FIG. 3 shows a plan view of thrust washer 40. As shown in FIGS. 2, 3, pad sets are defined by arcuate sections 100 that each include one pad 80 and one pad 82, with pads 80, 82 each having an arcuate shape. Arcuate sections 100 are separated by grooves 102 circumferentially between arcuate sections 100. More specifically, arcuate sections 100 and grooves 102 are arranged in an alternating manner in the circumferential direction such that each arcuate section 100 is circumferentially between two grooves 102 and each groove 102 is circumferentially between two arcuate sections 100. Grooves 102 are each defined by a strip 104 extending from inner circumferential surface 68 to outer circumferential surface 70 and first and second walls 106a, 106b protruding from strip 104. Walls 106a, 106b and strip 22 are each intersected by circumferentially extending groove 84. Walls 106a, 106b each define a radially extending circumferential edge of a respective arcuate section 100. Walls 106a, 106b each extend axially outward from strip 104 to the respective surface section axial surfaces 108, 110 and radially from inner circumferential surface 12 to outer circumferential surface 14.

Each arcuate section 100 includes one radially inner pad 80 and one radially outer pad 82. Pads 80 each include an arcuate axial surface 108 axially offset from strips 104 and pads 82 each include an arcuate axial surface 110 axially offset from strips 104, with surfaces 108, 110 each defining axial thrust surfaces of thrust washer 40. In other words, surface 108, 110 are axially further away from axial surface 72 of thrust washer 40 than strips 104. Arcuate axial surfaces 108 each extend from inner circumferential surface 68 to radially outer circumferentially extending surfaces 86 of radially inner pads 80, which define a radially inner circumferentially extending surface of groove 84, and each extend circumferentially from one first wall 106a to one second wall 106b. Arcuate axial surfaces 110 each extend from to radially inner circumferentially extending surfaces 88 of radially outer pads 82, which define a radially outer circumferentially extending surface of groove 84, to outer circumferential surface 70 and each extend circumferentially from one first wall 106a to one second wall 106b.

Each arcuate axial surface 108 is formed by two circumferential surface sections—an inclined surface section 112 and a flat surface section 114. Each section 112, 114 extends radially from inner circumferential surface 68 to radially outer circumferentially extending surfaces 86 of radially inner pads 80. Inclined surface section 112 tapers axially outward away from a first circumferential edge 116 thereof, which is coincident with an axially outermost edge 118 of wall 106a, to a second circumferential edge 120 thereof, which is coincident with a first circumferential edge 122 of flat surface section 114. Accordingly, arcuate section 108 is axially thicker at second circumferential edge 120 of inclined surface section 112 than at first circumferential edge 116 of inclined surface section 112. Flat surface section 114 is not axially inclined and extends from its first circumferential edge 122 to a second circumferential edge 124 thereof, which is coincident with an axially outermost edge 126 of wall 106b, without extending axially. In other words, flat surface section 114 is parallel with stator-side axial surface 72 and perpendicular to center axis 20 (FIG. 1). At flat surface section 114, arcuate section 100 has a constant thickness.

Similar to surfaces 108, each arcuate axial surface 110 is formed by two circumferential surface sections—an inclined surface section 128 and a flat surface section 130. Each section 128, 130 extends radially from radially inner circumferentially extending surfaces 88 of radially outer pads 82 to outer circumferential surface 70. Inclined surface section 130 tapers axially outward away from a first circumferential edge 132 thereof, which is coincident with an axially outermost edge 134 of wall 106a, to a second circumferential edge 1136 thereof, which is coincident with a first circumferential edge 138 of flat surface section 130. Accordingly, arcuate section 110 is axially thicker at second circumferential edge 136 of inclined surface section 128 than at first circumferential edge 132 of inclined surface section 128. Flat surface section 130 is not axially inclined and extends from its first circumferential edge 138 to a second circumferential edge 140 thereof, which is coincident with an axially outermost edge 142 of wall 106b, without extending axially. In other words, flat surface section 130 is parallel with stator-side axial surface 72 and perpendicular to center axis 20 (FIG. 1). At flat surface section 130, arcuate section 100 has a constant thickness.

The axial offset of pads 80, 82 is such that inclined surfaces 112 are axially offset from inclined surfaces 128 and flat surfaces 114 are axially offset from flat surfaces 130, with inclined surfaces 112 being axially further away from axial surface 72 than inclined surfaces 128 and flat surface 114 being axially further away from axial surface 72 than flat surfaces 130.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. An axial thrust washer for a torque converter comprising:
an inner circumferential surface;
an outer circumferential surface;
a first axial surface extending from the inner circumferential surface to the outer circumferential surface; and
a second axial surface opposite the first axial surface, the second axial surface including a plurality of radially inner pads and a plurality of radially outer pads, the radially inner pads extending axially further from the first axial surface than the radially outer pads.

2. The axial thrust washer as recited in claim 1 further comprising a circumferentially extending groove radially between the radially inner pads and the radially outer pads.

3. The axial thrust washer as recited in claim 1 wherein each of the radially inner pads and each of the radially outer pads having an arcuate shape.

4. The axial thrust washer as recited in claim 1 wherein the radially inner pads extend radially outward from the inner circumferential surface, the radially outer pads extending radially inward from the outer circumferential surface.

5. The axial thrust washer as recited in claim 1 wherein the second axial surface includes a plurality of arcuate sections, each arcuate section including one of the radially inner pads and one of the radially outer pads.

6. The axial thrust washer as recited in claim 5 wherein the arcuate sections are separated by grooves circumferentially between the arcuate sections such that the arcuate sections and the grooves are arranged in an alternating manner in a circumferential direction.

7. The axial thrust washer as recited in claim 1 wherein each of the radially inner pads includes a first surface section and a second surface section, the first surface section being tapered axially inward away from the second surface section.

8. The axial thrust washer as recited in claim 1 wherein each of the radially outer pads includes a first surface section and a second surface section, the first surface section being tapered axially inward away from the second surface section.

9. A torque converter comprising:
a stator;
an impeller; and
the axial thrust washer as recited in claim 1 axially between the stator and the impeller.

10. The torque converter as recited in claim 10 wherein the axial thrust washer is fixed to the stator.

11. The torque converter as recited in claim 10 wherein the radially inner pads are aligned with a radially inner section of a radially extending section of the impeller.

12. A method of forming a torque converter comprising:
forming an axial thrust washer including an inner circumferential surface, an outer circumferential surface, a first axial surface extending from the inner circumferential surface to the outer circumferential surface and a second axial surface opposite the first axial surface, the second axial surface including a plurality of radially inner pads and a plurality of radially outer pads, the radially inner pads extending axially further from the first axial surface than the radially outer pads; and
aligning the radially inner pads with a radially inner section of a radially extending section of the impeller.

13. The method as recited in claim 12 further comprising fixing the axial thrust washer to the stator.

14. The method as recited in claim 12 wherein the forming the thrust washer includes forming a circumferentially extending groove radially between the radially inner pads and the radially outer pads.

15. The method as recited in claim 12 wherein the forming the thrust washer includes forming the radially inner pads to extend radially outward from the inner circumferential surface and forming the radially outer pads to extend radially inward from the outer circumferential surface.

16. The method as recited in claim 12 wherein the forming the thrust washer includes forming each of the radially inner pads to include a first surface section and a second surface section, the first surface section being tapered axially inward away from the second surface section, the forming the thrust washer including forming each of the radially outer pads to include a first surface section and a second surface section, the first surface section being tapered axially inward away from the second surface section.
